(19) United States
(12) Patent Application Publication
(10) Pub. No.: US 2026/0253919 A1
(43) Pub. Date: Aug. 27, 2026

(54) FUEL CELL AND METHOD OF MANUFACTURING FUEL CELL

(71) Applicant: HONDA MOTOR CO., LTD., Tokyo (JP)

(72) Inventors: Yu YAMAGUCHI, Wako-shi (JP); Kazuo NUNOKAWA, Wako-shi (JP); Naoki TANAKA, Wako-shi (JP)

(21) Appl. No.: 19/545,952

(22) Filed: Feb. 20, 2026

(30) Foreign Application Priority Data
Feb. 26, 2025 (JP) 2025-029492

(51) Int. Cl. H01M 8/0273; H01M 8/0284; H01M 8/0286; H01M 8/1004; H01M 8/248; H01M 8/2483

(52) U.S. Cl. CPC H01M 8/0273; H01M 8/0284; H01M 8/0286; H01M 8/1004; H01M 8/248; H01M 8/2483

(57) ABSTRACT

A fuel cell includes a wet-side end unit. The wet-side end unit includes a wet-side end plate pressing a cell stack in a stacking direction of the cell stack. The cell stack includes a power generator with a plurality of power generation cells. The wet-side end unit further includes a reinforcement frame and fitted along an outer perimeter of a terminal plate. The terminal plate includes a current collector located at a position corresponding to the power generator. The wet-side end unit further includes fastening bolts fastening the reinforcement frame to an insulator. The insulator is provided on a side of the current collector closer to the wet-side end plate. An adhesive is applied to at least one of the fastening bolts.

### CROSS-REFERENCE TO RELATED APPLICATIONS

The present application claims the priority under 35 U.S.C. § 119 of Japanese Patent Application No. 2025-029492, filed on Feb. 26, 2025, the contents of which are hereby incorporated by reference in its entirety.

### BACKGROUND OF THE DISCLOSURE

### 1. Field of the Disclosure

The present disclosure relates to a fuel cell and a method of manufacturing the fuel cell.

### 2. Description of the Related Art

To secure hermeticity between a metallic member with a screwed through hole and a bolt head screwed in the screwed through hole, a gas sealing structure with a projection that is fitted in a joint surface has been used, which is known in the art, for example, in Patent Literature 1 (Japanese Patent No. 5904319). In this structure, a face of the bolt head is provided with the projection that bites into a substrate to maintain a gas sealing performance without using a gasket or a washer.

### SUMMARY OF THE DISCLOSURE

For example, an end unit provided on both ends of a cell stack of a fuel cell commonly includes different materials, which are a metallic plate of a terminal plate or an end plate and a resin insulator (insulating body). These materials are fitted to each other with a fastening bolt. In a conventional technique, when each plate as a reinforcement member and an insulator, which use different materials, are fitted by a fastening bolt, each material has a different thermal expansion coefficient. This may cause cracks to appear from a projection bitten by the fastening bolt. Furthermore, it is generally known that such a cell stack of the fuel cell is pressurized and fitted, causing a power generation unit to have high temperatures during power generation. This causes each component of the end unit to undergo a thermal expansion and contraction repeatedly due to temperature difference between start and stop of the fuel cell, possibly leading to loosening of the fastening bolt. Specifically, a fuel cell includes different materials with different thermal expansion coefficients, leading to further loosening. Such cracks and loosening may cause fuel gas leaks or air leaks of the fuel cell, leading to lower power generation performance or instability of power generation caused by water penetration into the power generation unit. These issues have room for further improvement. The present disclosure aims to provide a fuel cell and a method of manufacturing the fuel cell that prevents a fastening bolt from loosening caused by thermal expansion and contraction even when different materials are fastened together.

To overcome the above issues, a fuel cell of the present disclosure includes: a cell stack including a power generator with a plurality of stacked power generation cells each including a membrane electrode assembly and a separator; and an end unit provided on an end of the cell stack. The end unit includes: an end plate pressing the cell stack in a stacking direction of the cell stack; and a terminal plate to collect power from the power generator. The terminal plate includes: a current collector located at a position corresponding to the power generator; a reinforcement frame, fitted along an outer perimeter of the current collector, and having fastening parts; an insulator provided on a side closer to the end plate of the current collector; and fastening bolts fastening the reinforcement frame to the insulator. An adhesive is applied to at least one of the fastening parts in which the fastening bolts fasten the reinforcement frame to the insulator.

The present disclosure provides a fuel cell and a method of manufacturing the fuel cell that prevents a fastening bolt from loosening caused by thermal expansion and contraction even when different materials are fastened together.

### BRIEF DESCRIPTION OF DRAWINGS

FIG. 1 is a perspective view showing an entire configuration of a fuel cell according to an embodiment of the present disclosure;

FIG. 2 is a perspective view describing a configuration of an end unit;

FIG. 3 is a cross-sectional view taken along a line III-III of FIG. 1, simply showing fastening parts of the embodiment:

FIG. 4 is a plan view of a terminal plate viewed from a direction of a cell stack; and

FIG. 5 is a cross-sectional view describing an order of assembly for the end unit.

### EMBODIMENTS OF THE DISCLOSURE

Hereinafter, an embodiment of the present disclosure will be described in detail with reference to the drawings. In each drawing, the same components are given the same numerals, and duplicate descriptions are omitted. For convenience, following descriptions are given by three axes X, Y and Z perpendicular to one another as shown in the drawings. X represents a stacking direction, or a front-rear direction of a cell stack, Y represents a right-left direction, and Z represents a top-bottom direction. Configurations of each part will be described according to this definition. However, these directions do not necessarily correspond to, for example, a front-rear direction of an actual vehicle on which a fuel cell is equipped,

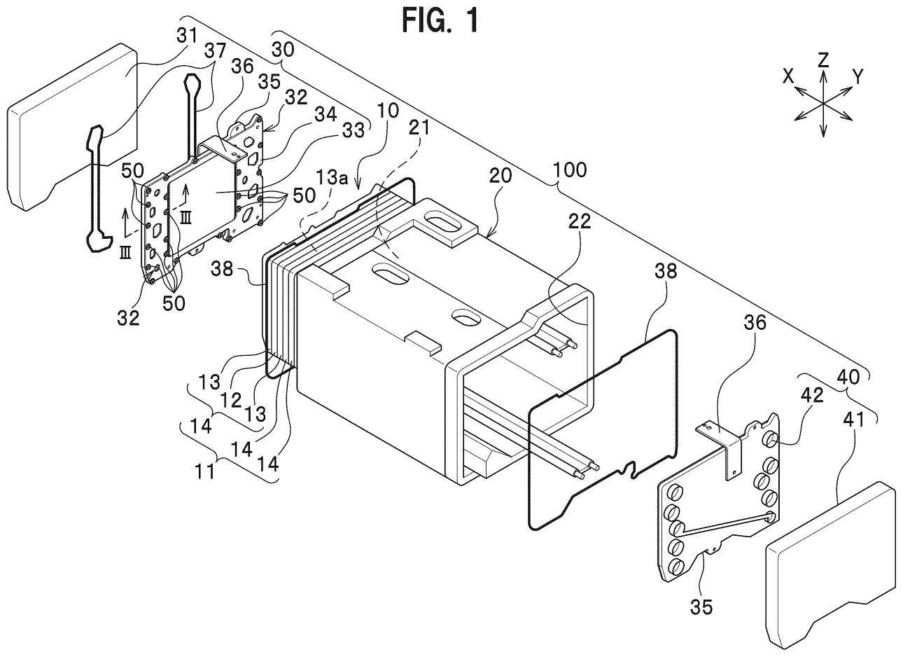

First, an entire configuration of a fuel cell 100 will be described with reference to FIG. 1. The fuel cell 100 includes a cell stack 10, a case 20 that surrounds and accommodates the cell stack 10, and a pair of wet-side end unit 30 and dry-side end unit 40 that are located on both ends of the case 20 and press the cell stack 10 in a stacking direction X of the cell stack 10. The fuel cell 100 has a rectangular parallelepiped shape as a whole. The cell stack 10, which constitutes a main component of a stack structure, includes a power generator 11 that includes a plurality of power generation cells 14 stacked. The power generation cell 14 includes a membrane electrode assembly 12 and a separator 13. A plurality of manifolds communicating in the stacking direction X is formed around the power generator 11 of the cell stack 10.

The case 20 has four substantially rectangular side walls each facing top, bottom, left and right surfaces of the cell stack 10. The case 20 is made of a metallic material such as aluminum and iron. Connecting these four side walls forms an accommodation space with a substantially box-shape that has two openings of a dry-side end opening 22 and a wet-side end opening 21.

The fuel cell 100 of the present embodiment includes the wet-side end unit 30 and the dry-side end unit 40 on the ends of the cell stack 10. The wet-side end unit 30 mainly includes a wet-side end plate 31 that seals one end of the case 20 and a terminal plate 32 located between the wet-side end plate 31 and the cell stack 10.

The dry-side end unit 40 mainly includes a dry-side end plate 41 that seals the other end of the case 20 and a terminal plate 42 located between the dry-side end plate 41 and the cell stack 10. The metallic wet-side end plate 31 of the wet-side end unit 30 and the dry-side end plate 41, shown in FIG. 1, are fitted respectively to the wet-side end opening 21 and the dry-side end opening 22 with a plurality of screws (not shown) with an intervening annular seal member 38. In this structure, the wet-side end plate 31 and the dry-side end plate 41 each inwardly press surfaces of both ends of the cell stack 10 in the accommodation space from both sides of the case 20 in the stacking direction X.

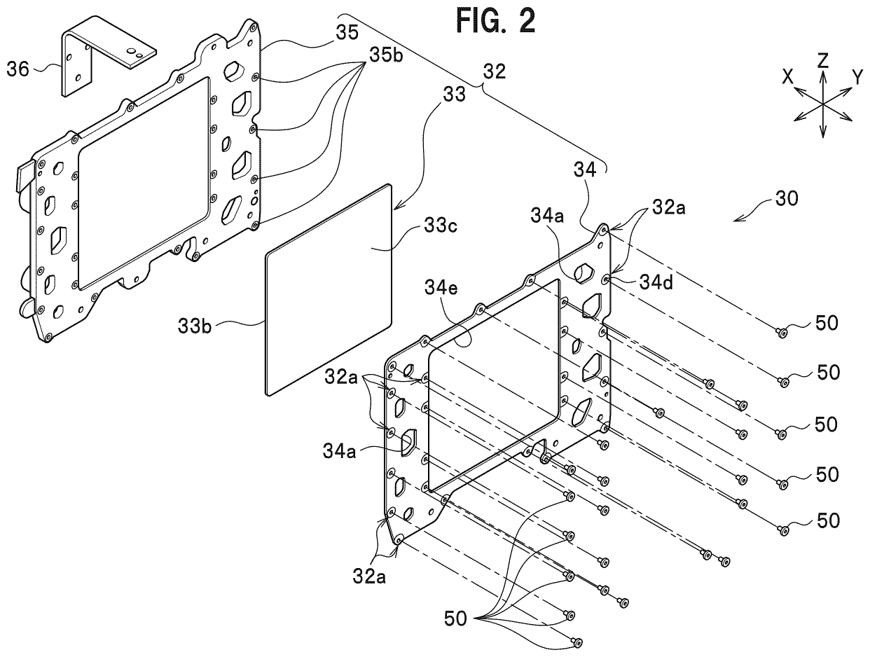

For example, the terminal plate 32 (see FIG. 2) is provided between the inside of the wet-side end plate 31 and the cell stack 10. The wet-side end plate 31 presses the planer terminal plate 32 inward from the outside with a plurality of intervening sealing members 37. This structure allows the cell stack 10, which is provided inside the terminal plate 32, to be held between the wet-side end unit 30 and the dry-side end unit 40 that are provided on opposite sides in the stacking direction X, and to be fixed in the accommodation space of the case 20, while the membrane electrode assembly 12 and the separator 13 are pressure joined together.

Next, the configuration of the wet-side end unit 30 included in the end unit of the embodiment will be described. The configuration of the dry-side end unit 40 is identical to the wet-side end unit 30 except shapes or other properties of the dry-side end plate 41 sealing the case opening, an insulator 35 located inside, and the terminal plate 42 located inside. Thus, a description of the configuration of the dry-side end unit 40 is omitted.

The terminal plate 32 (see FIG. 2) is provided between the inside of the wet-side end plate 31 and the cell stack 10. The wet-side end plate 31 presses the planer terminal plate 32 inward from the outside with the plurality of intervening sealing members 37. This structure allows the cell stack 10, which is provided inside the terminal plate 32, to be held between the wet-side end unit 30 and the dry-side end unit 40 that are provided on opposite sides in the stacking direction X, and to be fixed in the accommodation space of the case 20.

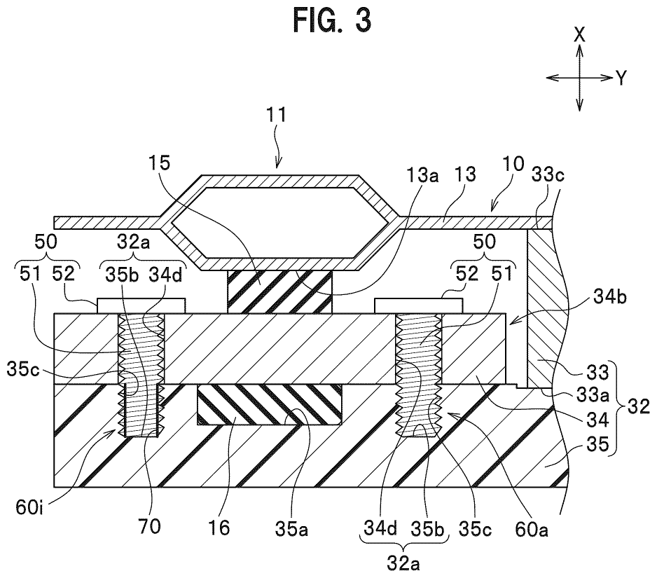

As shown in FIG. 2, the terminal plate 32, which is provided in the wet-side end unit 30 of the embodiment, includes a current collector 33 that collects electricity generated from the power generator 11, a reinforcement frame 34, the resin insulator 35 serving as an insulating member, and a plurality of fastening bolts 50 that fasten the reinforcement frame 34 to the insulator 35. The current collector 33 has an inner-side surface 33c in contact with a side surface 13a of the separator 13 located on opposite end surfaces in the stacking direction X of the cell stack 10 (see FIG. 3). The current collector 33 is connected to an L-shaped terminal 36 made of a metal. The power generated from the power generator 11 is collected by the current collector 33 and outputted to the outside of the case 20 via the terminal 36.

The reinforcement frame 34 of the embodiment, which is made of a metal such as stainless steel (SUS), is provided along the outer periphery of the terminal plate 32 in a frame shape. A sealing member 15 (see FIG. 3), which seals the periphery of a manifold opening formed on the cell stack 10 or other areas, is provided between the reinforcement frame 34 of the terminal plate 32 and the cell stack 10. The sealing member 15 is cured after being applied to make a desired interval between the reinforcement frame 34 and the cell stack 10.

Furthermore, as shown in FIG. 2, the wet-side end unit 30 includes the resin insulator 35 as an insulating body provided on a side of the current collector 33 closer to the wet-side end plate 31 than the dry-side plate 41. The insulator 35 formed with a plurality of manifold openings is provided on the substantially whole surface of the terminal plate 32. As shown in FIG. 1, the plurality of sealing member 37 that seal the periphery of the manifold openings is provided between the insulator 35 and the wet-side end plate 31. The insulator 35 is provided between the current collector 33 of the terminal plate 32 and the wet-side end plate 31 in such a way, allowing for insulation of a portion being energized, such as the current collector 33, from the case 20.

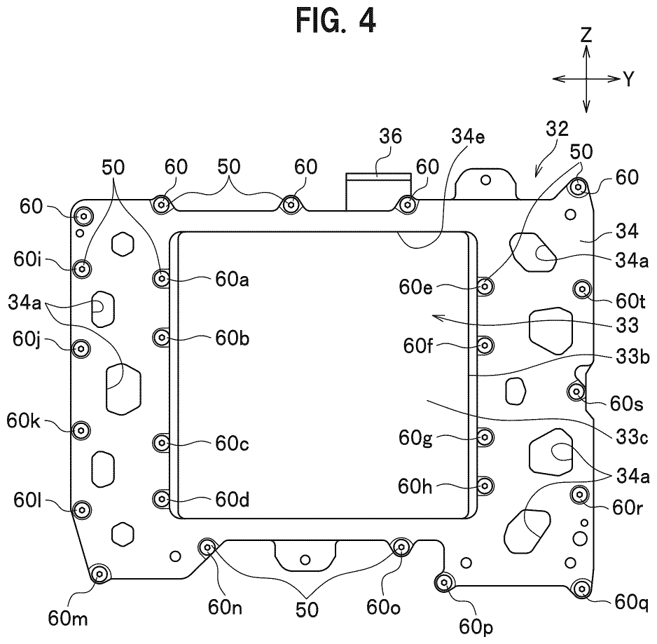

As shown in FIG. 4, the reinforcement frame 34 of the embodiment is made of a plate member. The reinforcement frame 34 is formed in a rectangular shape, which surrounds a central opening 34e in which the current collector 33 is located in a plan view. Furthermore, the reinforcement frame 34 is located outside an outer periphery 33b of the current collector 33 and inside the terminal plate 32 in a plan view with a predetermined width. The reinforcement frame 34 is formed with a plurality of communication openings 34a corresponding to the manifold openings formed on the side surface 13a of the separator 13. The communication openings 34a are formed in position to correspond to manifold communication holes provided in the cell stack 10 and the insulator 35 to communicate therewith.

Around the plurality of communication openings 34a, a gasket 16 is provided closer to the insulator 35, which corresponds in position to the sealing member 15 for the separator 13 (see FIG. 3). The gasket 16, made of a rubber, is fitted into a recessed groove 35a formed in the insulator 35. The gasket 16 is pressed between the reinforcement frame 34 and the insulator 35 to seal a gap therebetween.

As shown in FIG. 2, the terminal plate 32 has insertion holes 32a through which male screws 51 of the fastening bolts 50 are inserted respectively. The fastening bolts 50, which fix the reinforcement frame 34 to the insulator 35, are inserted through the insertion holes 32a in the stacking direction X. The insertion holes 32a of the embodiment correspond to bolt holes 34d formed through the reinforcement frame 34 and boss parts 35b recessed from the insulator 35 at positions corresponding to those of respective bolt holes 34d. The bolt holes 34d and the boss parts 35b are aligned each other in the stacking direction X. As shown in FIG. 3, each bolt hole 34d has an internal diameter larger than an external diameter of the male screw 51 of the fastening bolt 50 and smaller than an external diameter of a head 52 of the fastening bolt 50, having a size allowing for insertion in the stacking direction X. The boss part 35b has an inner wall formed with a female screw 35c that is threaded with the male screw 51 of the fastening bolt 50.

As shown in FIG. 2, each fastening bolt 50 is inserted from a direction of the terminal plate 32 into the corresponding insertion hole 32a to screw the male screw 51, or a distal end part, into the corresponding female screw 35c of the boss part 35b (see FIG. 3). The head 52 of the fastening bolt 50 has a back surface that comes in contact with an opening periphery of the bolt hole 34d to pressure join the reinforcement frame 34 to the insulator 35 under an axial force generated by the male screw 51 screwed into the female screw 35c. This allows the fastening bolts 50 to be fastened at a plurality of fastening parts 60 located outside, inner fastening parts 60a-60h, and outer fastening parts 60i-60t (hereinafter, these are described as the fastening parts 60 and the like), thereby fastening the reinforcement frame 34 of the terminal plate 32 to the insulator 35 (see FIG. 4).

In the fuel cell 100 of the present disclosure, an adhesive 70 is applied to at least one of the fastening parts 60 and the like. In the embodiment as shown in FIG. 3, the adhesive 70 is applied to at least one of the male screw 51 of the fastening bolt 50 and the female screw 35c formed in the boss part 35b of the insulator 35, in a range where the male screw 51 is inserted into the boss part 35b. However, the structure is not particularly limited to the above. The adhesive 70 can be applied to the female screw 35c, or applied to both the portion of the female screw 35c in a range where the male screw 51 is inserted into the boss part 35b and the female screw 35c.

Furthermore, in the fuel cell 100 of the embodiment, the adhesive 70 is not applied to the inner fastening parts 60a-60h among the plurality of fastening parts 60 and the like (see FIG. 3), which are located on an inner periphery 34b of the reinforcement frame 34 along the outer periphery 33b of the current collector 33 as shown in FIG. 4.

The adhesive 70 is applied to fastening parts including the plurality of fastening parts 60 located outside and the outer fastening parts 60i-60t shown in FIG. 4, which are located along the outer periphery 34c of the reinforcement frame 34 (see FIG. 3). That is, the adhesive 70 is applied to only the plurality of fastening parts 60 located outside and the outer fastening parts 60i-60t. The reinforcement frame 34 is fastened to the insulator 35 with the fastening bolts 50 at the inner fastening parts 60a-60h or the outer fastening parts 60i-60t. This allows the fastening bolts 50, which are screwed into the outer fastening parts 60 i-60t along the outer periphery 34c of the reinforcement frame 34, to be screwed and fastened by the applied adhesive 70 without loosening. This allows the gasket 16 press-fitted between the reinforcement frame 34 and the insulator 35 to maintain better sealing.

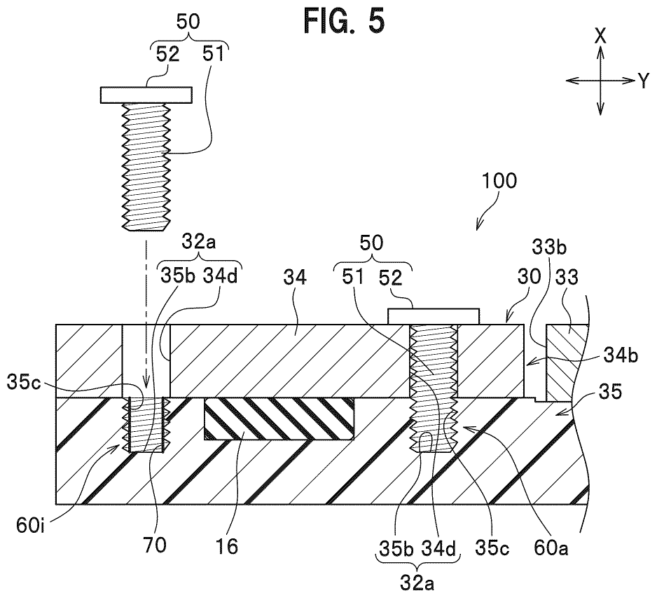

Next, a method of manufacturing the fuel cell of the embodiment will be described with reference to FIG. 5. In the method of manufacturing the fuel cell 100 of the embodiment, the adhesive 70 is previously applied to the female screws 35c formed on the boss parts 35b in the insulator 35 of the wet-side end unit 30, while the adhesive 70 is not applied to the inner fastening parts 60a-60h located on the inner periphery 34b of the reinforcement frame 34 along the outer periphery 33b of the current collector 33.

The fastening bolts 50 are inserted into the corresponding bolt holes 34d of the reinforcement frame 34 from the inside in the stacking direction X of the reinforcement frame 34 toward the boss parts 35b located outside. The distal ends of the male screws 51 of the fastening bolts 50 reach the female screws 35c of the insulator 35 before fixing the male screws 51 to the female screws 35c. This allows the fastening bolts 50 to fasten the reinforcement frame 34 of the terminal plate 32 to the insulator 35.

In the method of manufacturing the fuel cell 100 of the embodiment, the adhesive 70 is not applied to the male screw 51 of the fastening bolt 50, which is inserted from a direction of the reinforcement frame 34. This can eliminate the risk of the adhesive 70 remaining on the periphery or the inner wall surface of the bolt hole 34d when the fastening bolt 50 is inserted into the bolt hole 34d of the reinforcement frame 34.

As shown in FIG. 3, each fastening part 60 and the like is fastened by the corresponding fastening bolt 50. In such a step, the gasket 16 fixed to the recessed groove 35a of the insulator 35 seals the gap between the reinforcement frame 34 and the insulator 35 with the gasket being collapsed. Furthermore, as shown in FIG. 1, when the wet-side end plate 31 is attached to the wet-side end unit 30, the sealing member 37 seals the gap between the insulator 35 and the wet-side end plate 31. This allows the periphery of each manifold opening to be sealed by the sealing member 15 and the sealing member 37.

Meanwhile, the liquified sealing member 15, which is previously applied to the side surface 13a of the separator 13 located closer to the terminal plate 32 of the cell stack 10 shown in FIG. 3, has started curing. This allows, when the wet-side end unit 30 (see FIG. 1) is attached to the wet-side end opening 21 of the case 20, the reinforcement frame 34 to press and secure the cell stack 10 in the stacking direction X with the intervening sealing member 15, thereby preventing any movement of the cell stack 10 in the case 20.

However, the gasket can be subjected to an ambient heat from power generation by the power generator 11 or a sealed solution and thus can be degraded, causing a rubber of the gasket 16 to have a weakened reaction force. Such a condition may cause a deterioration of the axial force of the fastening bolt 50. Furthermore, vehicles equipped with the fuel cell 100 may experience instantaneous increase in the load on the sealing member 15 due to, for example, vibrations during travel.

For example, the cured liquified sealing member 15, which is previously applied to the side surface 13a of the separator 13, has greater elastic reaction force than the rubber gasket 16, and thus becomes difficult to collapse. This causes the gasket 16 to be collapsed due to the load applied on the sealing member 15 from the cell stack 10, causing an instantaneous decrease in the axial force of the fastening bolt 50. In such a case, loosening of the fastening bolt 50 may cause the head protruding inward in the stacking direction X to come into contact with the power generator 11.

In the present embodiment, the fuel cell 100 prevents the fastening bolt 50 from loosening due to thermal expansion and contraction, even when such different materials are fastened together. In particular, when the reinforcement frame 34 is fastened to the insulator 35 of the wet-side end plate 31 in the wet-side end unit 30 at the fastening parts 60, the gasket 16 is press-fitted between the reinforcement frame 34 and the insulator 35, and pushed into the recessed groove 35a. Therefore, even when the gasket 16 is subjected to an ambient heat from power generation or a sealed solution to be deteriorated and its reaction force decreases, the adhesive 70 applied to the fastening parts 60 prevents the fastening bolts 50 from loosening.

In the embodiment, the adhesive 70 is applied to the plurality of fastening parts 60 located outside and the outer fastening parts 60i-60t (see FIG. 3), which are located along the outer periphery 34a of the reinforcement frame 34 shown in FIG. 4. This method secures the fastening bolts 50, which are fastened at the plurality of fastening parts 60 located outside and the outer fastening parts 60i-60t, to the female screws 35c of the insulator 35 by the adhesive 70 without loosening. This prevents the fastening bolts 50 from loosening, even when different materials having different amounts of thermal extraction and contraction are used for the reinforcement frame 34 and the insulator 35, which are fastened together by the fastening bolts 50.

Furthermore, the adhesive 70 is not applied to the inner fastening parts 60a-60h (see FIG. 3), which are located on the inner periphery 34b of the reinforcement frame 34 along the outer periphery 33b of the current collector 33 as shown in FIG. 4. This method prevents the adhesive 70 from pealing off and entering the power generator 11 when the fastening bolts 50 are removed or installed during maintenance.

Furthermore, in the fastening parts 60 located outside and the outer fastening parts 60i-60t, both of which are located along the outer periphery 34c of the reinforcement frame 34 as shown in FIG. 4, the adhesive 70 is previously applied only to a portion in the range where the fastening bolt 50 is inserted into the boss part 35b of the insulator 35 as shown in FIG. 3. This method does not require applying the adhesive 70 to a portion of the fastening bolt 50 that is not inserted into the insulator 35, for example, a portion of the fastening bolt 50 that is inserted into the bolt hole 34d of the reinforcement frame 34. Thus, even when the fastening bolt 50 is removed or installed during maintenance, the method produces beneficial effects in practice such as reducing the amount of the adhesive 70 peeling off.

As described above, the fuel cell 100 includes the cell stack 10 that includes the power generator 11 with the multiple layers of the stacked power generation cells 14 each including the membrane electrode assembly 12 and the separator 13. The fuel cell 100 further includes the wet-side end unit 30 and the dry-side end unit 40 on opposite sides of the cell stack 10. Moreover, the wet-side end unit 30 includes the wet-side end plate 31 that presses the cell stack 10 in the stacking direction X and the terminal plate 32 that collects power from the power generator 11.

The terminal plate 32 includes the current collector 33 located at a position corresponding to that of the power generator 11, the reinforcement frame 34 having a frame shape located along the periphery of the current collector 33, and the insulator 35 located on the side closer to the wet-side end plate 31 of the current collector 33. The terminal plate 32 further includes the plurality of fastening bolts 50 that fasten the reinforcement frame 34 to the insulator 35. Moreover, the adhesive 70 is applied to at least one of the plurality of the fastening parts 60 that secure the reinforcement frame 34 to the insulator 35 by the fastening bolt 50.

The fuel cell 100 with such a construction provides the stacked structure that prevents the fastening bolt 50 from loosening due to thermal extraction and contraction even when different materials are fastened together.

As shown in FIG. 3, in at least one of the fastening parts 60 and the like that secure the reinforcement frame 34 to the insulator 35, the fastening bolt 50 is secured to the insulator 35 by the applied adhesive 70 and prevented from rotating not to loosen. This prevents the fastening bolt 50 from loosening even when different materials are fastened, such as the fastening bolt 50, the reinforcement frame 34, and the insulator 35 that have a different amount of thermal extraction and contraction.

The plurality of fastening parts 60 and the like include the fastening parts 60 located outside and the outer fastening parts 60 i-60t, which are located along the outer periphery 34c of the reinforcement frame 34. The fastening parts 60 and the like further include the inner fastening parts 60a-60h without the adhesive 70, which are located along the inner periphery 34b of the reinforcement frame 34. This prevents the adhesive 70 from peeling off even when the fastening bolts 50 are removed from or installed on the inner fastening parts 60a-60h along the outer periphery 34c of the current collector 33 during fastening or maintenance. Thus, the peeled adhesive 70 does not enter the power generator 11 and does not cause instability in power generation.

As shown in FIG. 3, the adhesive 70 is applied to fastening bolts 50 in the fastening parts 60, and the adhesive 70 is applied to at least one of the fastening bolts 50 in a range where the at least one of the fastening bolt 50 is inserted in the insulator 35.

In this structure, the adhesive 70 secures the fastening bolt 50 to the insulator 35 in a range where the fastening bolt 50 is inserted in the insulator 35 to prevent the fastening bolt 50 from rotating not to loosen. Furthermore, the adhesive 70 is not required to apply to a portion where the fastening bolt 50 is not inserted into the insulator 35, for example, a portion where the fastening bolt is inserted in the bolt hole 34d of the reinforcement frame 34. This prevents an increase in the amount of adhesive 70 that peels off during maintenance and reduces the risk of instability in power generation.

The method of manufacturing the fuel cell 100 includes a step of applying the adhesive 70 to at least one of the male screw 51 of the fastening bolt 50 and the female screw 35c formed on the insulator 35 and a step of fastening the reinforcement frame 34 to the insulator 35 by inserting the fastening bolt 50 into the female screw 35c from a direction of the reinforcement frame 34. The adhesive 70 is previously applied to the female screw 35c formed on the insulator 35, and the fastening bolt 50 is then inserted into the female screw 35c of the insulator 35 from the direction of the reinforcement frame 34 to fasten the reinforcement frame 34 to the insulator 35.

In the method of manufacturing the fuel cell 100 with such a structure of the present disclosure, the method prevents the fastening bolt 50 from loosening caused by thermal extraction and contraction even when different materials are fastened together. In detail, the fastening bolts 50 is screwed and fixed in the insulator 35 by the adhesive 70 previously applied to the female screw 35c of the insulator 35 even when the adhesive 70 is not applied to the fastening bolt 50 to be inserted from the direction of the reinforcement frame 34. This method produces beneficial effects in practice, for example, the method eliminates the risk of the adhesive 70 remaining on the fastening bolt 50 or the reinforcement frame 34 and then peeling off when the fastening bolt 50 is inserted from the direction of the reinforcement frame 34.

The present disclosure is not limited to the embodiment described above and allows various modifications. The embodiment has been described to facilitate understanding of the present disclosure and is not necessarily limited to those including all the configurations described above. Some configurations of the embodiment can be partly replaced with other configurations from other embodiments, or some configurations of the embodiment can be combined with configurations from other embodiments. Furthermore, the configurations of the embodiments can be partly removed, partly replaced with other configurations, or partly incorporated with other configurations. Followings are some possible modifications to the above embodiments.

As shown in FIG. 4, the adhesive 70 is not applied to some fastening parts 60 and the like of present embodiments, which are located along the outer periphery 34c of the current collector 33. Meanwhile, as shown in FIG. 3, the adhesive 70 is applied to at least one of the fastening bolts 50 in the fastening parts 60 to which the adhesive 70 is to be applied in a range where the fastening bolt 50 is inserted into the insulator 35. However, the present disclosure is not limited to this embodiment. For example, the adhesive 70 can be applied to one located along the outer periphery 34c of the current collector 33. The adhesive 70 can also be applied to some fastening bolts 50 corresponding to the reinforcement frame 34, which is not limited to a range where the fastening bolt 50 is inserted in the insulator 35. That is, in at least one fastening part 60 that fastens the reinforcement frame 34 to the insulator 35, the fastening bolt 50 remains screwed and fixed without loosening by the adhesive 70. Furthermore, the shape, number, and material of the fastening bolt 50 are not limited to this embodiment.

What is claimed is:

1. A fuel cell comprising:
a cell stack including a power generator with a plurality of stacked power generation cells each including a membrane electrode assembly and a separator; and
an end unit provided on an end of the cell stack, the end unit including:
an end plate pressing the cell stack in a stacking direction of the cell stack; and
a terminal plate to collect power from the power generator, the terminal plate including:
a current collector located at a position corresponding to the power generator;
a reinforcement frame, fitted along an outer perimeter of the current collector, and having fastening parts;
an insulator provided on a side of the current collector closer to the end plate; and
fastening bolts fastening the frame-shaped reinforcement member to the insulator, wherein
an adhesive is applied to at least one of the fastening parts in which the fastening bolts fasten the reinforcement frame to the insulator.

2. The fuel cell according to claim 1, wherein
each fastening part includes:
an outer fastening part provided on an outer periphery of the reinforcement frame; and
an inner fastening part provided on an inner periphery of the reinforcement frame, and
the adhesive is free from the inner fastening part.

3. The fuel cell according to claim 1, wherein
the adhesive is applied to fastening bolts in the fastening parts, and the adhesive is applied to at least one of the fastening bolts in a range where the at least one of the fastening bolts are inserted in the insulator.

4. A method of manufacturing the fuel cell according to claim 1 comprising:
applying the adhesive to at least one of a male screw of the fastening bolt and a female screw provided in the insulator; and
fastening the reinforcement frame to the insulator by inserting the fastening bolt into the corresponding female screw from a direction of the reinforcement frame.
